(19) United States
(12) Patent Application Publication
(10) Pub. No.: US 2022/0381247 A1
(43) Pub. Date: Dec. 1, 2022

(54) ELECTRICAL MACHINE

(71) Applicant: EPROPELLED LIMITED, Cardif (GB)

(72) Inventors: Nabeel Ahmed SHIRAZEE, Cathays, Cardiff (GB); Narotam Singh GREWAL, Sanbornton, NH (US)

(21) Appl. No.: 17/776,185

(22) PCT Filed: Nov. 11, 2020
(86) PCT No.: PCT/GB2020/052864

§ 371 Date: May 11, 2022

(30) Foreign Application Priority Data
Nov. 11, 2019 (GB) 1916347.6

(51) Int. Cl. F04D 13/06

(52) U.S. Cl. CPC F04D 13/064

(57) ABSTRACT

An electrical pump or generator apparatus comprises a sealed housing having fluid inlet and outlet ports and an impeller rotatably mounted inside a cavity of the housing, the impeller being mounted on a shaft for rotation about an axis, the shaft being confined inside the sealed housing. An electric machine of the pump has a stator disposed outside the housing and a rotor sealed inside the housing. In use a rotating magnetic field extends through a boundary wall of the housing to magnetically couple the stator and rotor on opposite sides of thereof. The need for a shaft seal is thus avoided and the apparatus is more compact than conventional pumps and generators.

### TECHNICAL FIELD OF THE INVENTION

The present invention relates to an electrical machine and more particularly, but not solely to an electrical pump for pumping liquids and other fluids and to a generator for efficiently producing electricity.

### TECHNICAL BACKGROUND OF THE INVENTION

Electrical pumps are well known. A typical fluid pump comprises a first (dry) portion in which an electrical motor is disposed and a second (wet) portion comprising a housing having fluid inlet and outlet ports and an impeller rotatably mounted inside a cavity of the housing for causing a flow of liquid from the inlet to the outlet port upon rotation thereof. The impeller is mounted on a rotary shaft of which extends from the motor through an aperture in a boundary wall of the housing, the wall separating the first and second portions of the pump. In some pumps, an elastomeric seal is disposed around the aperture and seals against the shaft, so as to prevent fluid escaping from the second portion to the first portion. In another embodiment, a seal is formed around the aperture by a rotatable o-shaped member of wear-resistant material which is sealed to the motor shaft and which is biased against a region of wear resistant material surrounding the aperture. Other types of seal are also known but all seals are prone to failure because they all rely on some form of sealing contact between the rotary motor shaft and the boundary wall which eventually breaks down. This problem can result in replacement of whole pump, for example because water contaminates a shaft bearing on in the first portion of the pump.

Typically, fluid pumps comprise induction motors which are bulky and heavy. By way of example, a 1.5 kW pump will typically comprise an induction motor weighing approximately 14 kg and having a diameter of 180 mm and a length of 270 mm. This causes issues when installing this kind of pump in a spa or a hot tub where space is very restricted due to heavy thermal insulation underneath the shell of the spa or hot tub. One method of improving efficiency is to use a pump having either a 3-phase induction motor or a permanent magnet motor having a variable speed drive. However, such pumps are still too bulky and still suffer from the above-mentioned seal failure problem.

With foregoing in mind, we have now devised an improved electrical pump.

### SUMMARY OF THE PRESENT INVENTION

In accordance with the present invention, as seen from a first aspect, there is provided an electrical pump comprising a housing having fluid inlet and outlet ports and an impeller rotatably mounted inside a cavity of a sealed housing for causing a flow of liquid from the inlet to the outlet port upon rotation thereof, the impeller being mounted on a shaft for rotation about an axis, the shaft being confined inside the sealed housing, the pump further comprising an electric motor having a stator disposed outside the housing and a rotor sealingly disposed inside the housing on said shaft, the stator having an electrical coil which, when energised, causes a rotating magnetic field to be radiated through a boundary wall of the housing to induce rotation of the stator and hence the impeller about said axis.

The shaft does not extend outside the housing and hence there is no need for a seal and the risk of leaking is avoided. Also, the provision of the rotor inside the housing allows a very compact stator to be used and hence the pump is smaller than a conventional pump of comparable power.

The rotor and impeller may be formed as a unitary body.

The motor may be a permanent magnet brushless motor.

The rotor may comprise an annular array of circumferentially spaced permanent magnets.

The impeller may comprise a body forming the rotor and one or more vanes which create the fluid flow.

A ferromagnetic member may be disposed on the opposite side of the stator to the rotor, so as close the magnetic circuit on the opposite side of the stator to the rotor. The ferromagnetic member acts to increase the throw (projection) of the magnetic field radiated towards the rotor and links the magnetic circuit allowing a stronger magnetic lock.

A ferromagnetic member may be disposed on the opposite side of the rotor to the stator, so as close the magnetic circuit on the opposite side of the rotor to the stator. The rotor, impeller and the ferromagnetic member may be formed as a unitary body.

In a first embodiment, the stator may be arranged to generate a rotating magnetic field which extends axially towards the rotor.

In this embodiment, the rotor magnets may have poles which face axially, the poles of adjacent magnets being opposite.

The rotating magnetic field generated by the stator windings or coils may radiate through the boundary wall and directly induce rotation of the rotor or the spinning of the magnets in the impeller may induce electricity in the coils of the stator.

In some cases, the magnetic field radiated by the stator may be too weak to directly induce rotation of the rotor, for example because the stator may be disposed too far away from the rotor or because the material between the stator and rotor has a low magnetic permeability. In order to solve this problem, a rotary coupling member may be disposed external of the housing between the stator and the rotor, the axis of rotation of the coupling member being colinear with the rotor axis. In use, the when energised, the stator radiates an electrical field to induce rotation of the coupling member. The coupling member radiates a magnetic field through the boundary wall of the housing to cause rotation of the rotor. The coupling member may comprise an annular array of circumferentially spaced permanent magnets. The magnets of the coupling member may have poles which face axially, the poles of adjacent magnets being opposite. The rotor and coupling member may have a like number of magnets.

The magnets of the coupling member magnetically lock with the magnets on of the rotor. This happens when the North pole of a magnet of the coupling member attracts the South pole of a magnet on the rotor. The magnets on the coupling member couple and closes the magnetic circuit with the magnets on the rotor and hence rotation of the coupling member causes rotation of the rotor. Coupling in this manner allows larger gaps between the coupling magnets and thicker non-ferromagnetic materials can be used for the housing and other parts that are disposed between the stator and rotor.

In a second embodiment, the stator may be arranged to generate a rotating magnetic which extends radially of the rotor through the boundary wall.

In this embodiment, the rotor magnets may have poles which face radially, the poles of adjacent magnets being opposite.

The rotor may be disposed radially outwardly of the stator or vice-versa, the boundary wall having a tubular portion disposed therebetween.

By reversing the process, i.e. passing the liquid through the impeller and spinning it will generate electricity in the coils of the stator. In this manner the contraption can be used in efficient hydro electricity production and can be scaled up to be installed in Dams or tidal electricity generation applications, etc.

Also, in accordance with the present invention, as seen from a second aspect, there is provided an electrical generator apparatus comprising a housing having fluid inlet and outlet ports and an impeller rotatably mounted inside a cavity of a sealed housing and arranged to rotate upon fluid flow through the housing from the inlet to the outlet port, the impeller being mounted on a shaft for rotation about an axis, the shaft being confined inside the sealed housing, the pump further comprising an electric generator having a stator disposed outside the housing and a rotor sealingly disposed inside the housing on said shaft, the rotor comprising a magnet which radiates a magnetic field through a boundary wall of the housing and which induces electrical current in a coil of the stator when the impeller is rotated about said axis.

By essentially reversing the process of operation of the electrical pump of the first aspect of the present invention, the apparatus can be used to generate electricity by causing a fluid flow through the housing to cause rotation of the impeller. In this manner the apparatus can be used for efficient hydro-electric generation and can be scaled up for installation in dams or tidal electricity generation schemes etc.

Also, in accordance with the present invention, as seen from a third aspect, there is provided an electrical apparatus comprising a housing for sealingly containing a fluid and having fluid inlet and outlet ports and an impeller rotatably mounted inside a cavity of the housing and arranged to rotate, the impeller being mounted on a shaft for rotation about an axis, the shaft being confined inside the sealed housing, the apparatus further comprising an electrical machine having a stator disposed outside the housing and a rotor sealingly disposed inside the housing on said shaft, the rotor comprising a magnet, the apparatus being arranged such that in use a rotating magnetic field extends through a boundary wall of the housing to magnetically couple the stator and rotor on opposite sides thereof.

The apparatus may be a pump in which the electrical machine is a motor arranged to rotate the impeller to cause a fluid flow from the inlet to the outlet.

The apparatus may be an electrical generator apparatus in which the electrical machine is a generator, the rotor inducing an electrical current in a coil of the stator when the impeller is rotated about said axis.

It will be appreciated that the aforementioned optional features of the electrical pump of the first aspect of the present invention are also applicable to the apparatus of the second or third aspects of the present invention.

### BRIEF DESCRIPTION OF THE DRAWINGS

Embodiments of the present invention will now be described by way of examples only and with reference to the accompanying drawings, in which:

FIG. 1 is an exploded view of an embodiment of electric pump in accordance with this invention;

FIG. 2 is a part cutaway perspective view of the rear of the assembled pump of FIG. 1 when viewed from the righthand side and above;

FIG. 3 is an exploded view of another embodiment of electric pump in accordance with this invention;

FIG. 4 is a perspective view of the rear of the assembled pump of FIG. 3 when viewed from the righthand side and above;

FIG. 5 is a part cutaway perspective view of the rear of the assembled pump of FIG. 3 when viewed from the righthand side and above;

FIG. 6 is an exploded view of a further embodiment of electric pump in accordance with this invention; and

FIG. 7 is a part cutaway perspective view of the rear of the assembled pump of FIG. 6 when viewed from the righthand side and above.

### EMBODIMENTS OF THE PRESENT INVENITON

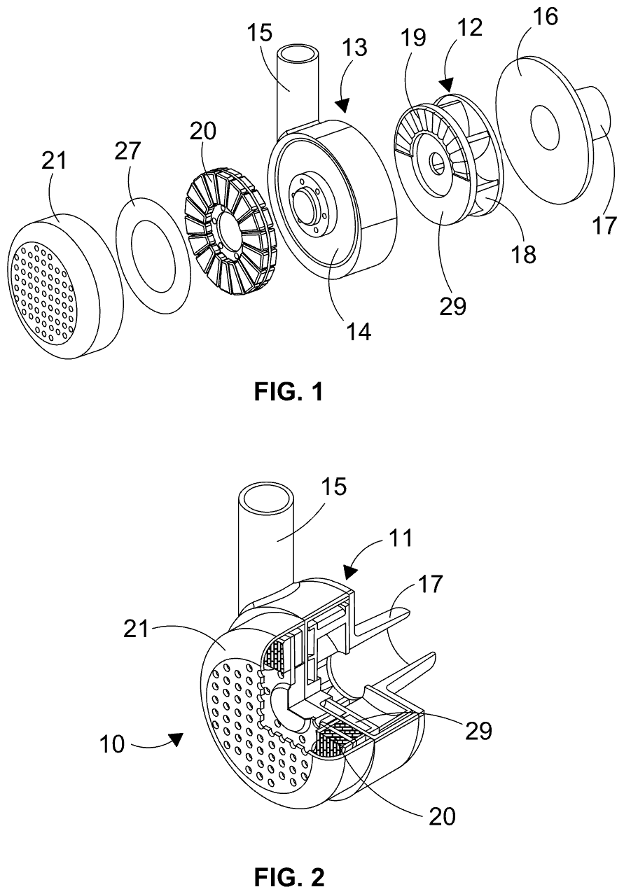

Referring to FIGS. 1 and 2 of the drawings, there is shown an electric pump 10 comprising a housing 11 having a front portion 16 and a rear portion 13 which are sealed together and which define an interior hollow cavity in which an impeller device 12 is rotatably mounted on a shaft (not shown) for rotation about an axis, the shaft being confined inside the sealed housing 11. The front portion 16 of the housing 11 comprises an axially extending fluid inlet port 17. The rear portion 13 of the housing 11 comprises a radially extending fluid outlet port 15. The inlet and outlet ports 17, 15 communicate with the interior hollow cavity in which the impeller device 12 is rotatably mounted.

The rear face of the impeller device 12 comprises a plurality of circumferentially spaced permanent magnets 19 forming an annular rotor 29, the magnets 19 having poles which face axially, the poles of adjacent magnets being opposite unless a Halbach arrangement or skew is opted. The magnets may be encapsulated within the body of the impeller device 12 (as shown in the lower arc of the impeller device 12 of FIG. 1). The front of the impeller device 12 comprises a plurality of vanes 18 which extend toward the inlet 17.

The pump 10 further comprises an annular stator 20 having a plurality of electrical coils, for example wound on a slotted former of laminated ferromagnetic material. The stator 20 is disposed outside the housing 11 adjacent a rear boundary wall 14 of the rear portion 13 of the housing 11. The annular stator 20 is centred about an axis which extends colinearly with the axis of rotation of the impeller device 12. An apertured rear cover 21 extends over the stator 20 and engages the rear portion 13 of the housing 11.

In use, the coils of the annular stator 20 are connected to a drive circuit (not shown) which causes the coils to radiate a rotating magnetic field which extends axially towards the rotor 29 through the boundary wall 14 of the housing 11. A ferromagnetic disc 27 is disposed on the opposite side of the stator 20 to the rotor 29, so as close the magnetic circuit. The ferromagnetic disc 27 acts to increase the throw (projection) of the magnetic field radiated from the stator 20 towards the rotor 29 and links the magnetic circuit allowing a stronger magnetic lock. The rotating magnetic field radiated by the stator 20 couples with the permanent magnets 19 of the rotor 29, thereby causing rotation of the impeller assembly 12 and pumping fluid from the inlet 17 to the outlet 15.

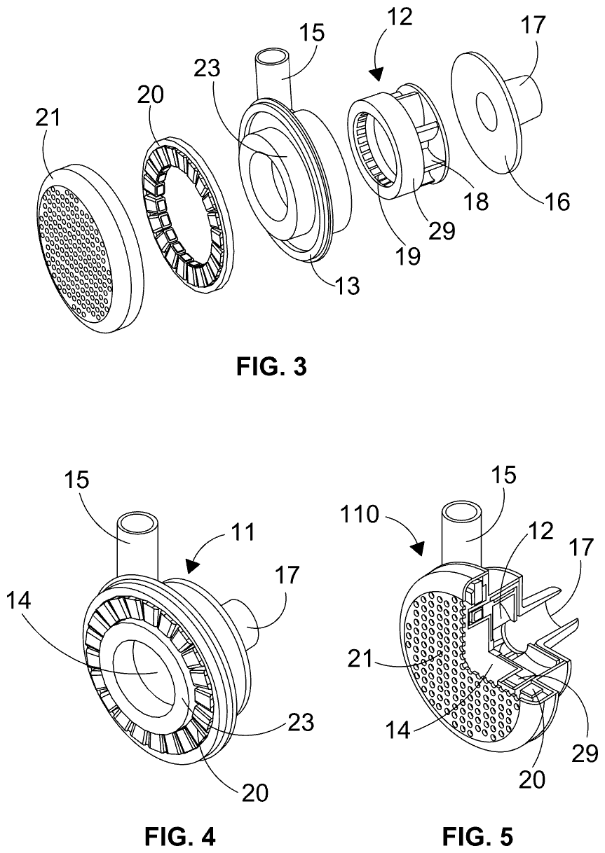

Referring to FIGS. 3, 4 and 5 of the drawings, there is shown an alternative embodiment of electric pump 110 which is similar in construction to the pump of FIGS. 1 and 2 and like parts are given like reference numerals. In this embodiment, the rear of the impeller device 12 comprises a tubular rotor 29 having a plurality of circumferentially spaced permanent magnets 19 arranged around its inner surface, the magnets 19 having poles which face radially, the poles of adjacent magnets 19 being opposite. The magnets 19 may be encapsulated within the body of the impeller device 12.

The tubular rotor 29 extends into an annular channel formation 23 disposed on the front face of the boundary wall 14 of the housing 11. The annular stator 20 is mounted against the rear face of the boundary wall 14 of the housing 11 and extends around the outer peripheral tubular wall of the annular channel formation 23 of the boundary wall 14.

In use, the coils of the annular stator 20 are connected to a drive circuit (not shown) which causes the coils to radiate a rotating magnetic field which extends radially inwardly towards the rotor 29 through outer peripheral tubular wall of the annular channel formation 23 of the boundary wall 14. The rotating magnetic field radiated by the stator 20 couples with the permanent magnets 19 of the rotor 29, thereby causing rotation of the impeller assembly 12 and pumping fluid from the inlet 17 to the outlet 15.

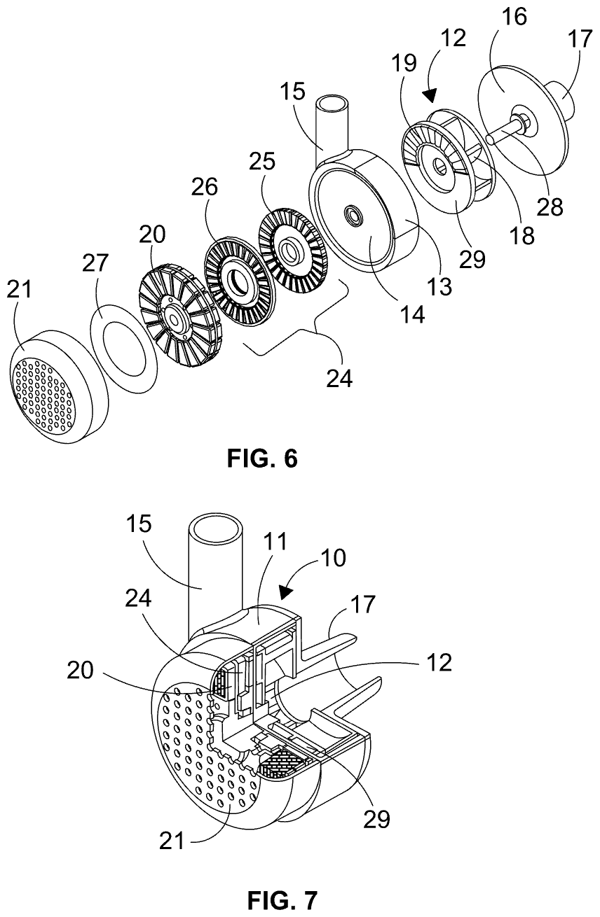

Referring to FIGS. 6 and 7 of the drawings, there is shown an alternative embodiment of electric pump 110 which is similar in construction to the pump of FIGS. 1 and 2 and like parts are given like reference numerals. In this embodiment, a coupling device 24 is disposed external of the housing 11 between the stator 20 and the rotor 29. The coupling device 24 is mounted for rotation about an axis which extends colinear with the rotational axis of the rotor 29.

The coupling device 24 comprises an annular array of circumferentially spaced permanent magnets 25 disposed in a former 26. The magnets 25 have poles which face axially towards the rotor 29, the poles of adjacent magnets 25 being opposite unless a Halbach arrangement or skew is opted. The former 26 may be moulded around the magnets 25 or the magnets may be set into the former 26.

In use, the coils of the annular stator 20 are connected to a drive circuit (not shown) which causes the coils to radiate a rotating magnetic field which induces rotation of the coupling device 24.

The permanent magnets 25 of the coupling device 24 radiate a magnetic field through the boundary wall 14 and magnetically lock with the permanent magnets 19 of the rotor 29. This happens when the North pole of a magnet 25 of the coupling device 24 attracts the South pole of a magnet 19 on the rotor 29. The magnets 25 on the coupling device 24 couple and close the magnetic circuit with the magnets 19 on the rotor 29 and hence rotation of the coupling device 24 by the magnetic field of the stator 20 indirectly causes rotation of the rotor 29. Coupling in this manner allows a larger gap between the stator 20 and rotor 29, and thicker non-ferromagnetic materials can be used for the housing 11 and other parts that are disposed between the stator 20 and rotor 29.

An electric pump 10 of the present invention thus avoids the need for a shaft to extend from the pump housing 11 to an external electric motor and hence there is no need for a seal and the risk of leaking is avoided. Also, the provision of the rotor 29 inside the housing allows a very compact stator 20 to be used and hence the pump 10 is smaller than a conventional pump of comparable power.

It will be appreciated that the embodiments of electric pump hereinbefore described may operate as an electrical generator by causing a fluid flow from the inlet to the outlet ports 17, 15. This causes the rotor 29 to rotate such that the permanent magnets 19 radiate a rotating magnetic field through the boundary wall 14 of the housing to magnetically couple the stator 20 and rotor 29 on opposite sides thereof, such that electrical current is induced in the stator coils.

1. An electrical pump comprising a housing having fluid inlet and outlet ports and an impeller rotatably mounted inside a cavity of a sealed housing for causing a flow of liquid from the inlet to the outlet port upon rotation thereof, the impeller being mounted on a shaft for rotation about an axis, the shaft being confined inside the sealed housing, the pump further comprising an electric motor having a stator disposed outside the housing and a rotor sealed inside the housing on said shaft, the stator having an electrical coil which, when energised, causes a rotating magnetic field to be radiated through a boundary wall of the housing to induce rotation of the stator and hence the impeller about said axis.

2. (canceled)

3. An electrical pump as claimed in claim 1, in which the rotor comprises an annular array of circumferentially spaced permanent magnets.

4. (canceled)

5. (canceled)

6. An electrical pump as claimed in claim 3, in which the poles of adjacent magnets are opposite.

7. An electrical pump as claimed in claim 3, in which the poles of adjacent magnets are in Halbach arrangement.

8. An electrical pump as claimed in claim 1, in which a ferromagnetic member having a low reluctance path is disposed on the opposite side of the stator to the rotor or vice-versa.

9. An electrical pump as claimed in claim 1, in which a rotary coupling member is disposed external of the housing between the stator and the rotor, an axis of rotation of the coupling member being colinear with an rotor axis.

10. An electrical pump as claimed in claim 9, in which the coupling member comprises an annular array of circumferentially spaced permanent magnets.

11. An electrical pump as claimed in claim 10, in which the magnets of the coupling member and rotor each have poles which face axially, the poles of adjacent magnets being opposite.

12. An electrical pump as claimed in claim 10, in which the magnets of the coupling member and rotor each have poles which face axially, the poles of adjacent magnets being in a Halbach arrangement.

13. (canceled)

14. An electrical generator apparatus comprising a housing having fluid inlet and outlet ports and an impeller rotatably mounted inside a cavity of a sealed housing and arranged to rotate upon fluid flow through the housing from the inlet to the outlet port, the impeller being mounted on a shaft for rotation about an axis, the shaft being confined inside the sealed housing, the apparatus further comprising an electric generator having a stator disposed outside the housing and a rotor sealed inside the housing on said shaft, the rotor comprising a magnet which radiates a magnetic field through a boundary wall of the housing and which induces electrical current in a coil of the stator when the impeller is rotated about said axis.

15. (canceled)

16. An electrical generator apparatus as claimed in claim 14, in which the rotor comprises an annular array of circumferentially spaced permanent magnets.

17. (canceled)

18. (canceled)

19. An electrical generator apparatus as claimed in claim 16, in which the poles of adjacent magnets are opposite.

20. An electrical generator apparatus as claimed in claim 16, in which the poles of adjacent magnets are in Halbach arrangement.

21. An electrical generator apparatus as claimed in claim 14, in which a ferromagnetic member having a low reluctance path is disposed on the opposite side of the stator to the rotor or vice-versa.

22. An electrical generator apparatus as claimed in claim 14, in which a rotary coupling member is disposed external of the housing between the stator and the rotor, an axis of rotation of the coupling member being colinear with a rotor axis.

23. An electrical generator apparatus as claimed in claim 22, in which the coupling member comprises an annular array of circumferentially spaced permanent magnets.

24. An electrical generator apparatus as claimed in claim 23, in which the magnets of the coupling member and rotor each have poles which face axially, the poles of adjacent magnets being opposite.

25. An electrical generator apparatus as claimed in claim 23, in which the magnets of the coupling member and rotor each have poles which face axially, the poles of adjacent magnets being in a Halbach arrangement.

26. (canceled)

27. An electrical apparatus comprising a housing for sealingly containing a fluid and having fluid inlet and outlet ports and an impeller rotatably mounted inside a cavity of the housing and arranged to rotate, the impeller being mounted on a shaft for rotation about an axis, the shaft being confined inside the sealed housing, the apparatus further comprising an electrical machine having a stator disposed outside the housing and a rotor sealed inside the housing on said shaft, the rotor comprising a magnet, the apparatus being arranged such that in use a rotating magnetic field extends through a boundary wall of the housing to magnetically couple the stator and rotor on opposite sides thereof.

28. (canceled)

29. An electrical apparatus as claimed in claim 27, in which the apparatus is a electrical generator apparatus and the electrical machine is a generator, the rotor inducing an electrical current in a coil of the stator when the impeller is rotated about said axis.
